(19) United States
(12) Patent Application Publication
(10) Pub. No.: US 2008/0218789 A1
(43) Pub. Date: Sep. 11, 2008

(54) Method of allocating rip workload in digital printing

(75) Inventor: George L. Eldridge, Long Beach, CA (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/714,652

(22) Filed: Mar. 6, 2007

(51) Int. Cl. G06K 15/00

(52) U.S. Cl. 358/1.15

(57) ABSTRACT

A document to be printed digitally has each page image routed to an RIP of least capability able to timely process the image if that RIP is least busy. If the RIP of least capability able to timely process the image is not the least busy, the page image is routed to the RIP of next greater capability. Page images including colored material are routed to the RIP of greater capability and to a color printer. Page images including graphical material or larger than letter size are routed to an RIP of greater capability. Page images containing no colored material are sent to a monochrome printer, if available; and, if not, are sent to a color printer.

### BACKGROUND

The present disclosure relates to digital printing and particularly, printing on equipment that employs a plurality of raster image processors in the printing workflow. In particular, the disclosure relates to digital printing systems in which the tasks of the raster image processor are distributed to a collection of computing elements. Heretofore, for parallel workflow the pages of the document have been subdivided into groups or segments of the document which are then distributed to the computing elements of the system. Thus, colored pages and pages containing graphical material may be interspersed in the document to be printed with pages of plain black and white text. The memory and performance requirements for printing the black and white plain text are much lower, and, thus, it is inefficient to print such pages on expensive processors having a large memory and high performance for printing colored pages.

Another example of inefficiency in digital document printing is the situation where the document to be printed includes pages of letter size and those of larger than letter size such as tabloid or pages having 11″×17″ measurement. If the document is segmented such that the images for the larger pages are included in the same segment with the letter size pages and the segment is sent to a computing element of limited capability such as, for example limited memory capacity or relatively low performance or speed, the larger size pages could not be printed through that computing element. Thus, the computing element needed to have sufficiently large memory and performance capability to print pages larger than letter size. However, if plain text letter size pages are included in the same document segment the result is inefficient use of equipment for printing the letter.

It has therefore been desired to provide a way or means of utilizing distributed computing elements in a digital printing system for segmenting the printing job in a manner employing the least costly computing elements thus improving the efficiency of the printing process.

### BRIEF DESCRIPTION

The method of the present disclosure segments a document to be printed digitally according to the content of each page image and routes the page image to the least capable, and thus, least costly computing element such as, for example a raster image processor (RIP) able to handle the content and size of the page image where the least capable computing element is available at the time. If the least capable computing element is not available, the method of the present disclosure routes the page image to a computing element having the next higher level of capability. If the page image is colored, the method routes the page image to the highest capable computing element and to a color printer. If the page image contains graphical material, the method employed routes the image to a computing element with a relatively high capability such as higher memory capacity and/or performance. If the page image has dimensions greater than letter size, the image is routed to the computing element having the highest capability, but if the page image does not contain colored material, the image need not be printed on a color printer if a monochrome printer is available. If the image is not larger than letter size and does not contain graphical or colored material, the page image is then routed to the computing element having the lowest capability and is directed to a monochrome printer if currently available.

### BRIEF DESCRIPTION OF THE DRAWINGS

FIG. 1 is a block diagram of the method of the present disclosure employing two raster image processors; and

FIG. 2 is a block diagram similar to FIG. 1 of a system according to the present method employing four raster image processors of varying capability.

### DETAILED DESCRIPTION

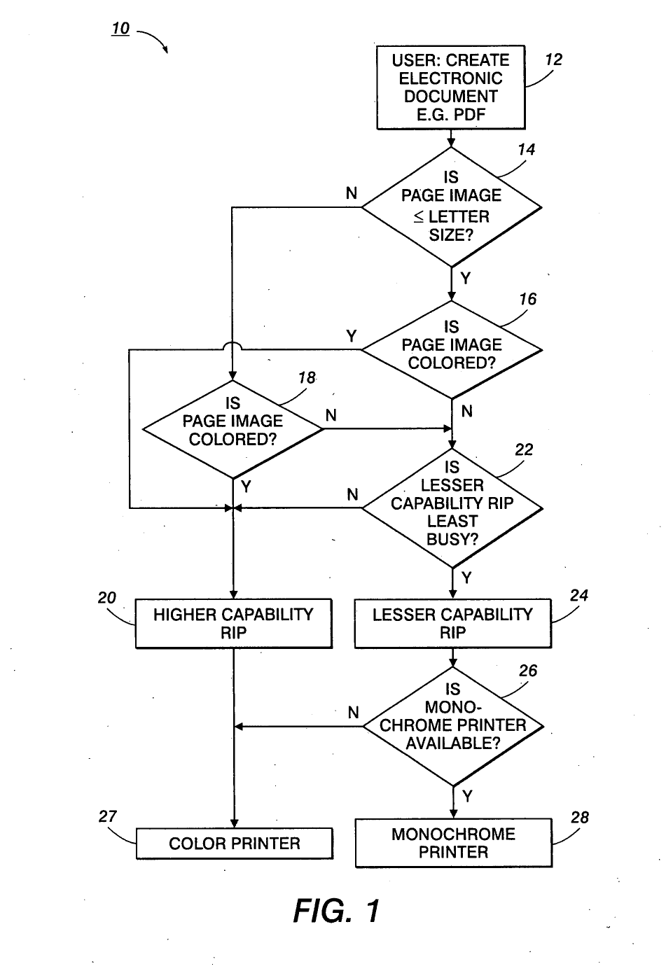

Referring to FIG. 1, the method of the present disclosure is illustrated for one exemplary embodiment in which a system, indicated generally at 10, begins at step 12 where the user creates the electronic document such as, for example, a PDF, by inputting a printed document to a scanner or creating an electronic document in a computer. The system proceeds to ask at step 14 whether the page image is equal to or less than letter size; and if the determination at step 14 is affirmative, the system proceeds to step 16 and inquires as to whether the page image contains colored material; and, if the determination is affirmative, the system proceeds to input the page image at step 20 to an RIP of relatively high capability.

However, if the determination at step 14 is negative (e.g. the page image is greater than letter size), the system proceeds to step 18 and queries as to whether the page image is colored; and, if the determination is affirmative, the image is inputted to the RIP at step 20.

If the determination at step 16 is negative, the system proceeds to step 22 and queries as to whether an RIP of lesser capability is least busy.

If the determination at step 22 is negative, the image is inputted to the RIP of higher capability at step 20; however, if the determination at step 22 is affirmative, the system proceeds to step 24 and inputs the image into an RIP of lesser capability.

The images from the higher capability RIP at step 20 are sent directly to the color printer at step 27. The images inputted to the RIP of lesser capability at step 24 proceed to step 26 where the system inquires as to whether a monochrome printer is available; and, if not, the image is sent to the color printer at step 27. However, if the query at step 26 is answered in the affirmative, the images are sent to a monochrome printer at step 28.

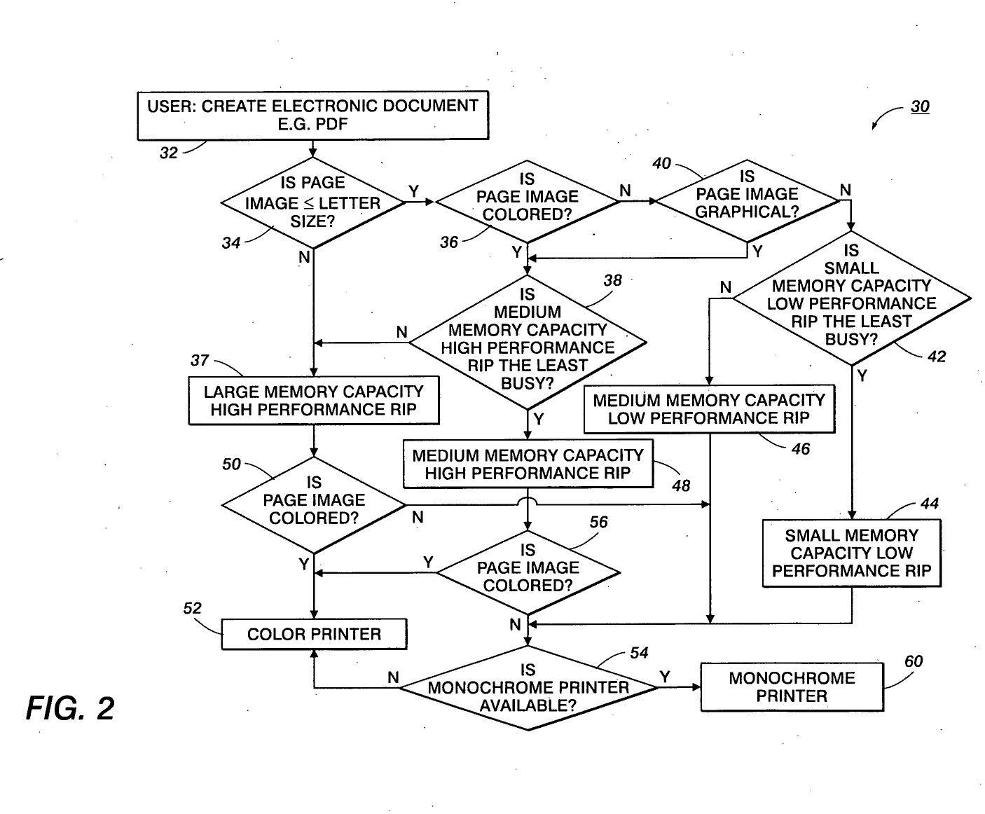

Referring to FIG. 2, another exemplary embodiment of the method of the present disclosure is illustrated wherein the system, indicated generally at 30, responds at step 32 to the user creating an electronic document, as for example a PDF created from a scanner or electronically on a computer is inputted to the system.

The system then proceeds to step 34 and queries as to whether the page image is less than or equal to letter size; and, if the determination is negative, the system proceeds to an RIP having a large memory capacity and high performance at step 37. If the determination at step 34 is affirmative, the system proceeds to step 36 and queries as to whether the page image contains colored material; and, if the determination at step 36 is affirmative, the system proceeds to step 38 and queries as to whether an RIP with medium memory capacity and high performance is the least busy. However, if the determination at step 36 is negative, the system proceeds to step 40 and inquires as to whether the page image contains graphical material.

If the determination at step 40 is affirmative, the system proceeds to step 38; however, if the determination at step 40 is negative, the system proceeds to step 42 and queries as to whether an RIP with small memory capacity and low performance is the least busy.

If the determination at step 42 is affirmative, the system proceeds to send the page image to step 44 and inputs the image to an RIP of small memory capacity and low performance. However, if the determination in step 42 is negative, the system proceeds to step 46 and inputs the page image to an RIP of medium memory capacity and low performance.

If the determination at step 38 is negative, the image is sent to the large memory capacity high performance RIP at step 37. However, if the determination at step 38 is affirmative, the image is sent to step 48 and inputted to an RIP of medium memory capacity and high performance.

The output of the RIP at step 37 is forwarded by the system to step 50 where inquiry is made as to whether the page image contains colored material; and, if the query is answered in the affirmative, the system forwards the image to the color printer at step 52. However, if the determination at step 50 is negative, the system forwards the image to step 54 where an inquiry is made as to whether a monochrome printer is available.

The output of the RIP at step 48 is forwarded by the system to step 56 where an inquiry is made as to whether page image contains colored material; and, if the query is answered in the affirmative, the system sends the image to colored printer at step 52. However if the determination at step 56 is answered in the negative, the system sends the image to step 54.

The output of the RIP at step 46 is forwarded to step 54 as is the output of the RIP at step 44.

If the determination at step 54 is negative, the images are forwarded to the color printer at step 52. However, if the determination at step 54 is affirmative, the images inputted thereto are distributed to the monochrome printer at step 60.

The present method thus determines the content of each page image of a digital document and, depending upon the content thereof as to whether each page image contains colored, graphical, or text material or is larger than letter size, the method distributes the individual page to the computing element, or raster image processor, of the lowest capability that is able to implement printing of the page if the RIP of lesser or lower capability is available at the time; otherwise, the image is sent to the RIP having the next higher level of capability. The method of the present disclosure thus seeks to maximize the efficiency of the individual computing elements or RIPs available in the particular digital printing system.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of allocating raster image processor (rip) workload in digital printing comprising:
(a) generating an electronic image of a document to be printed;
(b) providing a first RIP with a relatively high capability and a second RIP having a lesser capability than the first RIP;
(c) assigning each page image of the document to the first RIP when the page is colored;
(d) assigning each non colored image to the second RIP when it is least busy and to the first RIP when the second RIP is not the least busy; and,
(e) printing the page image.

2. The method defined in claim 1, wherein the step of printing includes:
(a) printing the page, if colored on a color printer; and,
(b) printing the page image, if not colored on a monochrome printer if available and if not then on a colored printer.

3. The method defined in claim 1, wherein the step of providing a first RIP includes providing an RIP having one of a relatively high memory capacity and high performance and providing a second RIP having one of a lesser memory capacity and lesser performance than the first RIP.

4. A method of allocating Raster Image Processor (RIP) workload in digital printing comprising:
(a) generating an electronic image of a document to be printed;
(b) providing a first raster image process (RIP) with large memory capacity having relatively high performance, a second raster image processor with medium memory capacity having relatively high performance, a third raster image processor with medium memory capacity having relatively low performance, and a fourth raster image processor with small memory capacity having relatively low performance;
(c) assigning each page image of the document to the first RIP when the page image is either one of larger than letter size and colored;
(d) assigning each page image of the document when the page image is one of colored and graphical to the second RIP if least busy and if not then to the first RIP;
(e) assigning each page image of the document when it is not one of (i) larger than letter size, (ii) colored, and (iii) graphical to the fourth RIP if least busy and if not then to the third RIP; and,
(f) printing the image.

5. The method defined in claim 4, wherein the step of printing includes:
(a) printing the page image, if colored, on a color printer; and,
(b) printing the page image, if not colored on a monochrome printer if available and if not then on a colored printer.

6. The method defined in claim 4, wherein the step of providing a first RIP includes providing an RIP having four computing elements each with a four gigabyte memory capacity.

7. The method defined in claim 4, wherein the step of providing a fourth RIP includes providing an RIP with a computing element with a two gigabyte memory capacity.
